(19) United States
(12) Patent Application Publication
(10) Pub. No.: US 2002/0123151 A1
(43) Pub. Date: Sep. 5, 2002

(54) Method and apparatus for rapid measurement of acidity in juice

(76) Inventor: Richard M. Ozanich, Richland, WA (US)

Correspondence Address: Floyd E. Ivey, Liebler, Ivey & Connor, P.O. Box 6125, Kennewick, WA, 99336, US

(21) Appl. No.: 09/799,950

(22) Filed: Mar. 5, 2001

(51) Int. Cl. G01N 31/16; G01N 31/22

(52) U.S. Cl. 436/163; 436/164; 436/166

(57) ABSTRACT

The invention relates to a method for rapid measurement of acidity in juice. A sample vial is quantitatively filled with juice and transferred to a mixing vessel. A drop of pH indicator solution is added to the mixing vessel. While swirling to mix, a calibrated dropper is used to add a known concentration of titrant. The titrant is added and the number of drops that are required to cause a color change is noted. The number of drops of titrant used is multiplied by a predetermined conversion factor to generate a percent acidity value appropriate for the sample type. Different concentrations of titrant or different volumes of sample, with different conversion factors, are used, depending on the level of acidity expected in the sample. The method is rapid, with accuracy and precision comparable to traditional burette titrations.

### FIELD OF THE INVENTION

The invention relates to a method for rapid measurement of acidity in juice.

### BACKGROUND OF THE INVENTION

The measurement of acidity in fruit juice is an indicator of fruit and juice characteristics. Certain characteristics will be important, for example, in relation to choice of horticultural methods, harvest timing, shipping decisions, storage decisions, and quality sorting. The traditional method of measurement is by use of a burette in a standard laboratory acid-base measurement process. The laboratory equipment required is expensive, fragile and not easily portable. The process is lengthy. Current methods for measuring acidity in juice use expensive laboratory auto-titrators, or manual titration with a burette. Manual burette titration is laborious and, for many industry decisions, provides a degree of precision that is far beyond what is necessary or useful. Burettes are large, cumbersome, easily broken and not suitable for use in the field or on the factory floor.

Knowing the acidity of juice is important for growers, packers, shippers, and processors to make intelligent management and process decisions. Product quality and properties of juice is highly dependent on the percent acid content, in addition to the sugar content.

### SUMMARY OF THE INVENTION

The invention relates to a simplified method for rapid measurement of acidity in juice. The method has been shown to rapidly, accurately and precisely measure acidity in fruit juice when compared to traditional burette titrations. The present invention relates to a method and an apparatus for rapid measurement of acidity in juice. Drop count titration kits for measuring acidity in water are known, but these methods have never been extended to the analysis of juice. While the apparatus are similar, there are several notable exceptions to the use of a drop-count titration kit for measuring acidity in juice as indicated in the Detailed Description.

### BRIEF DESCRIPTION OF THE DRAWINGS

FIG. 1 demonstrates a calibrated dropper 1, having a sealing cap, a known concentration of titrant 15 contained within a titrant container 10.

FIG. 2 shows a sample vial 25 is filled with fruit juice 20.

FIG. 3 illustrates a pH indicator solution 35 within a pH indicator container 40, having a pH indicator sealing cap 30.

FIG. 4 illustrates a mixing vessel 45.

FIG. 5 is a flow diagram of the process of the invention.

### DETAILED DESCRIPTION

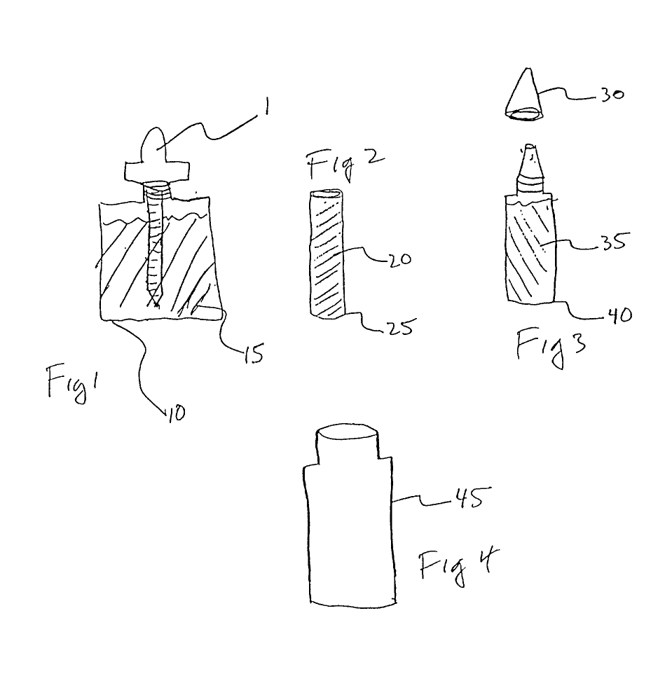

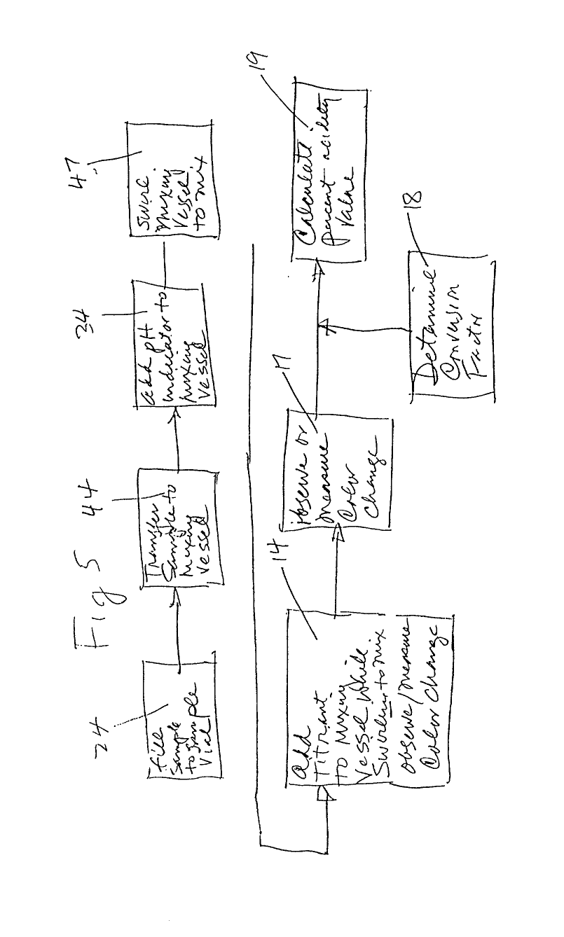

FIGS. 1 through 4 illustrate the apparatus of the disclosure. The process or method of the invention is illustrated in FIG. 5. A sample vial 25 is quantitatively filled 24 with fruit juice 20 and transferred 44 to a mixing vessel 45. A drop of pH indicator solution 35 within pH indicator container 40, having a pH indicator sealing cap 30, is added 34 to the mixing vessel 45. While swirling 47 to mix, a calibrated dropper 1, having a sealing cap, is used to add 14 a known concentration of titrant 15 contained within a titrant container 10. Those of ordinary skill in the chemical arts will recognize that other means of providing known volumes of solution may be utilized. The titrant 15 is added and the number of drops that are required to cause an observable or measurable 17 color change in the fruit juice 20 in the mixing vessel 45 is noted. The number of drops of titrant 15 used is multiplied by a predetermined conversion factor 18 to generate or calculate 19 a percent acidity value appropriate for the fruit juice 20 sample type. Different concentrations of titrant 15 and/or different volumes of sample 20, using different sizes of sample vial 25, with different conversion factors, are used depending on the type of fruit juice 20 and depending on the level of acidity expected in the fruit juice 20 sample.

Because of the inherent color of many juices 20, a more concentrated solution of pH indicator 35 is necessary relative to that necessary for measurement of acidity of water. Typically, phenolphthalein is used as a pH indicator solution 35 that changes from colorless to pink when the final drop of titrant 15 is added. Many other pH indicator solutions 35 are known and may be used for the appropriate fruit juice 20 titration. When this color change occurs, the total number of drops of titrant 15 added to the mixing vessels are multiplied by the conversion factor to produce a percent acidity value. The conversion factor allows conversion of the number of drops of titrant 15 used to a percent acidity in the fruit juice 20 sample. The conversion factor will necessarily differ with each different titrant 15 and fruit juice 20 type.

The present method also utilizes multiple titrant containers 10 of titrant 15 having low, medium and high concentrations. This allows the user flexibility in choosing 1) a standard method using medium concentration titrant 15 yielding typical analysis time, accuracy and precision, 2) a rapid analysis method, using high concentration titrant 15 giving fair accuracy and precision, or 3) a slightly more lengthy analysis method, using a low concentration titrant 15, yielding high accuracy and precision.

As a particular example in measuring acidity of apple juice, different titrant 15 concentrations would be used depending on the variety of apple. The high acidity of Granny Smith apple juice would be most effectively measured with a comparably high concentration of titrant 15 to have a good balance between analysis time and accuracy and precision. The low acidity levels of Red Delicious apple juice would be most effectively measured with a comparably low concentration of titrant 15.

Depending on the application, a higher or lower concentration of titrant 15 might be used. For example, in a production environment with high time pressures, a rapid titration may be most important. In this case, a higher concentration of titrant 15 than that normally used would provide a faster analysis because fewer drops will be needed to affect a color change. However, in the case of research, a lower concentration of titrant 15 than that normally used would provide a high degree of accuracy, precision and resolution because many more drops will be needed to affect a color change.

Different titrant 15 concentrations can be stored in titrant containers 10 having different colors, e.g., green for high concentration Granny Smith titrant 15, red for low concentration Red Delicious titrant 15. A check standard can be provided with the other apparatus and used in place of the sample to verify method accuracy, e.g., a standard concentration, known to the user, e.g., % total acidity as malic acid for apple juice, % citric acid for citrus fruit juice and % tartaric acid for grape juice or wine, etc.

All solutions, titrant 15 and pH indicator 35, can be supplied by a centralized source responsible for maintaining accurate concentrations, thus minimizing the cost and potential errors of individual small-scale preparation of solutions.

Another example describes an apparatus for rapid measurement of acidity in fruit juice 20 by means of drop-count titration. The apparatus (FIG. 1) comprises a sample vial 25 that is used to measure a known volume of sample fruit juice 20. A pH solution container 40, comprised of a dropper bottle or a bottle having a dropper, containing pH indicator solution 35 is used to add a drop of indicator to the mixing vessel 45. The fruit juice 20 sample is also added to the mixing vessel 45 and the two solutions are swirled to mix. A calibrated dropper 1 that dispenses known and repeatable volume drops of titrant 15 contained in re-sealing titrant container 10 is used to add titrant 15 to a mixing vessel 45 containing a known volume of fruit juice 20 sample and a drop of pH indicator 35. The mixing vessel 45 is swirled to mix the contents as titrant 15 is added dropwise. The number of drops of titrant 15 required to change the color of the fruit juice 20 and pH indicator solution 35 is noted and multiplied by a the pre-determined conversion factor appropriate for the particular concentration of titrant 15 used and sample volume used, thus producing a percent acidity value.

The method is additionally demonstrated by the following examples: 1). using a low concentration of titrant, e.g., 0.01 Molar sodium hydroxide or potassium hydroxide for low acidity samples, e.g., Red Delicious apple juice; 2). using a medium-range concentration of titrant, e.g., 0.05 Molar sodium hydroxide or potassium hydroxide, for moderately acidic samples, e.g., Fuji apple juice; 3). using a high concentration of titrant, e.g., 0.1 Molar sodium hydroxide or potassium hydroxide, for high acidity samples, e.g., Granny Smith apple juice; 4). using a higher concentration of titrant when a more rapid analysis time is preferred with less but acceptable accuracy and precision; 5). using a lower concentration of titrant when a more accurate and precise analysis is preferred, at the expense of a longer analysis time.

I claim:

1. A method for rapid measurement of acidity in juice, comprising:
a. transferring fruit juice to a mixing vessel;
b. adding pH indicator solution to the mixing vessel and mixing the resulting contents of the mixing vessel;
c. adding titrant to the mixing vessel until the color of the contents in the mixing vessel changes indicating the acidity value for the sample type.

2. The method of claim 1 further comprising:
a. transferring a known volume of fruit juice to a mixing vessel;
b. adding a known volume of pH indicator solution to the mixing vessel and mixing the resulting contents of the mixing vessel;
c. adding a known concentration and volume of titrant to the mixing vessel until the color of the contents in the mixing vessel changes indicating the acidity value for the sample type.

3. The method of claim 2 further comprising:
a. filling a sample vial having a known volume with fruit juice and transferring the known volume of fruit juice to a mixing vessel;
b. adding a drop, of known volume, of pH indicator solution to the mixing vessel and mixing the resulting contents of the mixing vessel;
c. adding a known concentration of titrant, drop-wise by drops of known volume, to the mixing vessel while swirling the contents of the mixing vessel;
d. adding and counting said drops of titrant to the mixing vessel until the color of the contents in the mixing vessel changes;
e. multiplying the number of said drops of titrant by a predetermined conversion factor generating a percent acidity value appropriate for the sample type;
f. rinsing the mixing vessel with water in preparation for the next fruit juice sample and rinsing the sample vial with a small amount of the next fruit juice sample for best accuracy;
g. checking the accuracy of the measurement by measuring the acidity of a check standard to verify method accuracy.

4. The method of claim 3 further comprising: using a calibrated dropper to add drops of pH indicator solution and of titrant; using at least one pH indicator solution; using at least one titrant.

5. The method of claim 4 further comprising: using at least the pH indicator solution of phenolphthalein.

6. The method of claim 4 further comprising: using at least the pH indicator solution of bromcresol green indicator.

7. The method of claim 4 further comprising: using at least the pH indicator solution of methyl red indicator.

8. The method of claim 4 further comprising: using at least the pH indicator solution of bromthymol blue indicator.

9. The method of claim 4 further comprising: using at least the pH indicator solution of methyl violet indicator.

10. The method of claim 4 further comprising: using at least the pH indicator solution of methyl orange indicator.

11. The method of claim 4 further comprising: using at least the pH indicator solution of thymol blue indicator.

12. The method of claim 4 further comprising: using at least the pH indicator solution of bromphenol blue indicator.

13. The method of claim 4 further comprising: using at least the pH indicator solution of alizarin yellow R indicator.

14. The method of claim 4 further comprising: using at least the pH indicator solution of universal indicator.

15. The method of claim 4 further comprising: using at least sodium hydroxide titrant.

16. The method of claim 4 further comprising: using at least potassium hydroxide titrant.

17. The method of claim 4 further comprising: using at least calcium hydroxide titrant.

18. The method of claim 4 further comprising: using visual detection of color change.

19. The method of claim 4 further comprising: using photometric detection of color change.

20. The method of claim 4 further comprising: using electrochemical detection of titration endpoint or equivalence point.

21. An apparatus for rapid measurement of acidity in juice, comprising:
a. one or more sample vials for measuring a known volume of sample,
b. a dropper bottle for adding a non-quantitative drop of pH indicator solution,
c. a mixing vessel into which is added the contents of the sample vial and a drop of pH indicator solution,
d. a calibrated dropper that dispenses known and repeatable volume drops of titrant,
e. one or more titrant containers containing one or more concentrations of titrant,
f. a check standard quality control solution (e.g., a known percent malic acid solution) that is used to verify method accuracy,
g. predetermined conversion factors for each concentration of titrant that, when multiplied by the number of drops of titrant, produce a value in percent acidity or other units desirable for the particular application.
